(19) United States
(12) Patent Application Publication
(10) Pub. No.: US 2011/0179684 A1
(43) Pub. Date: Jul. 28, 2011

(54) DISPLAY DEVICE FOR VEHICLES

(76) Inventor: Eugene A. Blaho, Brea, CA (US)

(21) Appl. No.: 12/691,946

(22) Filed: Jan. 22, 2010

(51) Int. Cl. G09F 21/02

(52) U.S. Cl. 40/591

(57) ABSTRACT

A vehicle with a trunk where the trunk lid pivots upwardly to provide access to the trunk and a latch for holding for the trunk lid closed is provided with a removable display device in the rear of the vehicle. The display device comprises a sheet of flexible material having a display on an outer surface thereof, an upper pocket or the upper edge of the sheet with a first rod therein for holding the display device in the trunk when the trunk is closed, and optionally a lower pocket with another rod therein for maintaining the displayed device displayed while the vehicle moves. Optionally there is a cutout in an upper portion of the sheet for receiving the latch.

### BACKGROUND

Vehicle owners frequently desire to place a message on their vehicles such as a warning sign, an advertisement, a slogan, or a declaration of allegiance to a favorite sports team. Many techniques have been developed for attaching such messages to vehicles, such as bumper stickers, magnetic mounting systems, license plate frames, devices mountable on antennas, and the like. See, for example, U.S. Pat. No. 5,255,464 for a tailgate sign; and U.S. Pat. No. 3,949,503 for an emergency warning device.

Problems with many such devices are they can be difficult to secure in place and/or difficult to remove.

Thus there is a need for a display device for use on vehicles that is easily secured to a vehicle and easily removable.

### SUMMARY

The present invention is directed to such a device. In particular, it is designed for placement on the rear of a vehicle that has a rear door that pivots for opening to provide access to a rear compartment, where the rear door is closed by a latch. The rear door can be a trunk lid or a swinging door of the type used with vans and SUVs. The device comprises a sheet of flexible material, first and second opposed surfaces, an upper portion, a lower portion, an upper edge, and a lower edge. There is a display such as “Go Team” on the first surface so it serves as a display surface. There are retaining means proximate to the upper edge for removably retaining the sheet in the rear compartment of the vehicle when the rear door is closed, but not when the rear door is open. Optionally the device also includes weight down means at the lower edge of the sheet for maintaining the display surface visible while the vehicle moves. The retaining means can comprise a pocket at the upper edge of the sheet with one or more rods located therein. There is no support for the sheet that prevents the sheet from bending so that the upper portion can be placed in the rear compartment with the lower portion of the sheet draping downwardly so that the display is visible.

Optionally and preferably there is an opening in the upper portion of the sheet for receiving a latch, such as a latch typically present in the trunk of a vehicle for holding the trunk lid closed. The opening is sized so that the latch can pass through the opening, where the latch is captured in the opening.

Preferably the weight down means comprises one or more rods proximate to the lower edge of the sheet.

Padding can optionally be provided to prevent the rods from marring the vehicle surfaces.

Because the display device is held in place by a very simple retaining means that is effective when the rear door is closed but not when the rear door is open, and optionally with the opening for a latch, the display device is easily and quickly attachable to a vehicle, and is equally easily removable from the vehicle.

### DRAWINGS

These and other features, aspects, and advantages of the present invention will be better understood with reference to the following description, appended claims, and accompanying drawings where:

FIG. 1 shows a display device according to the present invention mounted in the trunk of a vehicle with the trunk lid open;

FIG. 2 is a front perspective view of the device of FIG. 1; and

FIG. 3 is a vertical sectional view of the device of FIG. 1 taken on line 3-3 in FIG. 2.

### DESCRIPTION

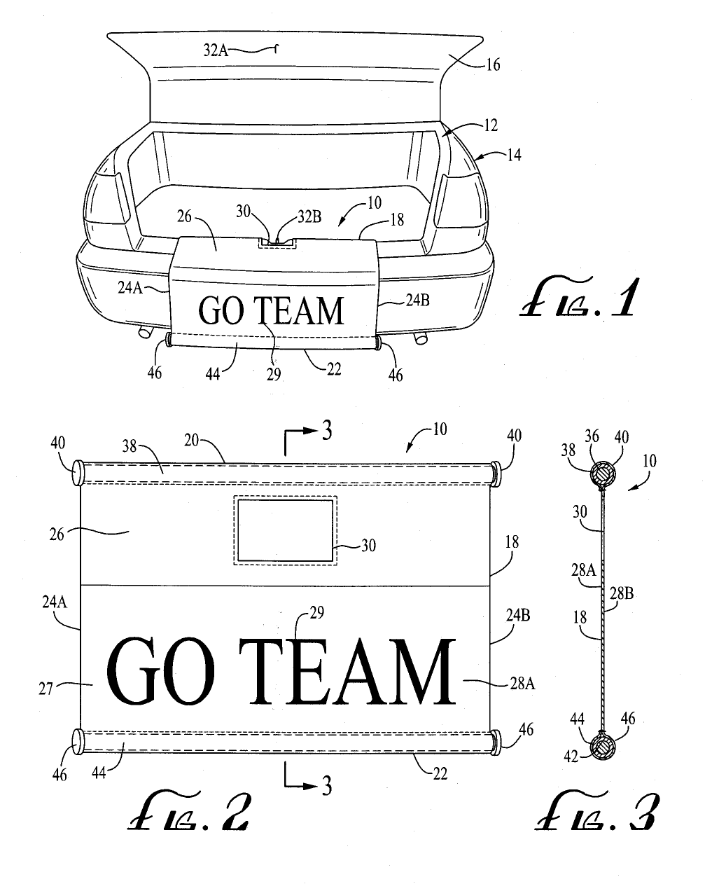

A display device 10 having features of the present invention is designed for mounting in a rear compartment, such as a trunk 12, of a vehicle 14. As is typical, the trunk 12 has a trunk lid 16 pivotable between an open position and a closed position. The closed position is also referred to as the latched position. The trunk lid 16 is shown in the open position in FIG. 1.

The display device is formed from a sheet 18 of flexible durable material. Flexible materials such as cloth, leather, cotton, canvas, plastic, paper or durable plastic/fiber substitute such as that manufactured by DuPont under the TYVEK mark can be used. The plastic can be any durable, flexible plastic, such as polyvinylchloride or polyethylene. The sheet 18 can include a coating to provide UV resistance and durability. Optionally the sheet 18 is washable.

The sheet 18 has an upper edge 20, a lower edge 22, opposed side edges 24A and 24B, an upper portion 26, a lower portion 27, and opposed first 28A and second 28B surfaces. The surface facing outwardly is referred to herein as a display surface, which is the first surface 28A in the figures. The first surface 28A has a display 29 thereon, typically only on the lower portion 27, since the upper portion 26 of the display surface is not easily visible when the device is in use. Optionally both surfaces 28A and 28B of the sheet 18 can be used for display purposes, where the surfaces have the same or different displays. Different displays provide for versatility and different messages. Thus which of the surfaces 28A and 28B serves as the display surface depends on how the device is oriented relative to the vehicle. The “display” surface is the surface facing outwards.

By using a flexible sheet 18 of material, it is possible to easily roll up the display device for compact storage in the trunk or elsewhere when it is not being used for display purposes.

There is no support for the sheet that prevents the sheet from bending so that the upper portion can be placed in the trunk with the lower portion of the sheet draping downwardly so that the display surface is visible.

The sheet 18 can be a single piece of material, or multiple segments attached together. For example, the upper portion 26 can be formed of a first material and the lower portion 27 of a second material, stitched, glued or welded together. The first and second materials can differ only in color or surface treatment. For example, the upper portion 26 can be dark colored, such as black, and the lower portion 27 can be a light color so that the display 29 is easily visible. Preferably the sheet 18 is rectangular in configuration, having a width of from about 30 to about 36 inches and a height of from about 24 to about 30 inches. Shapes, such as square, oval, round, hexagonal, triangular, and pentagonal, are also possible.

Preferably the upper portion 26 of the sheet 18 has a cut out 30, also referred to as an opening, centrally located with respect to the side edges 24A and 24B for receiving a latch mechanism 32 of the vehicle 14 so that the latch mechanism 32 can capture the device 10. The latch mechanism 32 is used to hold the trunk lid 16 in its closed position. The latch mechanism has an upper portion 32A that engages a lower portion 32B. This cut out 30 prevents damage to sheet 18 when the trunk lid 16 is closed, as well as helping to secure the display device 10 in the trunk 12 when the trunk lid 16 is closed. Optionally a removable patch can be provided to cover the cut out 30 for applications where the cut out 30 is not needed. The cut out patch can be held in place by a fastener, such as Velcro brand hook and loop fastener.

The display 29 on the display surface 28A can be any indicia desired, including letters, numbers and graphical designs. The display 29 typically is one that shows support for a sports team, such as “Go Lakers,” “Go Nationals,” “Go Orioles,” “Go Bears,” “Go Angels,” and the like. The display 29 may include a team logo. The display 29 can also be a warning sign of the type found on bumper stickers such as “Baby on Board,” an advertisement (such as “Call XYX for patent work”), can be a warning display, a display requesting assistance, such as “Flat Tire,” or “Call AAA,” or an announcement such as “Just Married.”

The side edges 24A and 24B can be hemmed or otherwise strengthened.

To retain the sheet 18 in the trunk 12 when the trunk lid 16 is closed, retaining means, such as an upper retaining rod such as a bar or dowel or multiple retaining rods, separated or attached, can be placed proximate to the upper edge 20 of the sheet 18. The retaining means is sized to be too large to pass through the gap between the vehicle body and a door, such as the trunk lid 16, closing the compartment, such as the trunk, in which the retaining means is located. Preferably a single upper rod 36, which can be made of wood, metal, or rigid plastic can be used. The upper rod 36 can be placed in a hemmed upper sleeve 38 at the upper edge 20. The sleeve 38 can be formed by stitching or otherwise attaching one doubled over portion of the sheet 18 to the opposed portion. The upper rod 36 can be shorter than, equal to or longer in width than the width of the sleeve 38. In one version of the invention, the upper rod 36 extends slightly out of the sleeve 38 and is provided with caps 40 being of larger diameter than the diameter of the sleeve 38 so that the upper rod 36 cannot slide out of the sleeve 38. The diameter of the upper rod 36 is slightly smaller than the inside diameter of the sleeve 38 to ensure a tight fit.

To keep the sheet 18 vertically oriented and avoid flapping when the vehicle 14 is moving, optionally weight down means are provided proximate to the lower edge 22 of the sheet. The weight down means can be any weighting device of sufficient weight so that the sheet 18 resists flapping. The weight down means can be sewn in metallic weights or the like. Preferably the weight down means is one or more heavy rods 42 at the bottom. There can be a bottom sleeve 44 formed by hemming at the lower edge 22 of the sheet 18, with the bottom rod 42 therein. The bottom rod 42 can be made of wood, metal, or rigid plastic. The bottom sleeve 44 can be formed by stitching or otherwise attaching one doubled over portion of the sheet 18 to the opposed portion. The bottom rod 42 can be shorter than, equal to or longer in width than the width of the bottom sleeve 44. In one version of the invention, the bottom rod 42 extends slightly out of the bottom sleeve bottom and is provided with caps 46 being of larger diameter than the diameter of the bottom sleeve 44 so that the bottom rod 42 cannot slide out of the bottom sleeve 4. The diameter of the bottom rod 42 is slightly smaller than the inside diameter of the bottom sleeve 44 to ensure a tight fit.

The rods 36 and 42 can be any shape in cross section, such as circular, polygon, and oval. They can be solid or hollow.

To prevent marring the vehicle 14, the upper rod 56 and the lower rod 42 can be partially or completely surrounded by padding 52. The padding 52 can be attached to the respective rod. The padding 52 can be formed of any protective material, such as foam.

Optionally the rods 42 and 56 can be sized to be removable from the sheet so that the sheet can be easily cleaned or folded.

A method according to the present invention for placing the display device 10 on the rear of the vehicle comprises opening the rear door such as the trunk lid 16 of the vehicle 14, placing the retaining means and a portion of the sheet 18 inside a trunk with the remainder of the sheet 18 draping over the rear of the vehicle, without physically securing the display device 10 to the vehicle 14, and closing the trunk lid 16. When the vehicle has a latch for the trunk lid and the upper portion of the sheet has the opening sized to receive the latch, the opening is placed over the latch so that the latch extends through the opening and helps to retain the display device in place when the trunk lid is closed

Although the present invention is described in considerable detail with reference to certain preferred versions thereof, other versions are possible. For example, the invention can be used not only with a conventional trunk lid, but with any vehicle having a rear compartment with a pivotable door. For example it can be used with an SUV having a door that pivots upwardly or sidewardly. Also, depending on the size of the upper retaining means, the trunk lid need not be completely closed for the display device 10 to be held in place. Thus the present claims should not be limited to the description of the preferred versions contained herein.

1. A display device suitable for placement on the rear of a vehicle that has a trunk and a trunk lid that pivots upwardly for opening to provide access to the trunk, the trunk having a latch, the display device comprising:
a) a generally rectangular sheet of flexible material having first and second opposed surfaces, an upper edge, a lower edge, an upper portion, a lower portion, and a cut out in the upper portion for receiving the latch when the trunk is closed;
b) a first display on the first surface; and
c) an upper pocket proximate to the upper edge of the sheet with a first rod therein for removably retaining the sheet in the rear compartment of the vehicle when the trunk lid is closed; and
d) padding for the first rod,
wherein there is no support for the sheet that prevents the sheet from bending so that the upper portion can be placed in the trunk with the lower portion of the sheet draping downwardly so that the display is visible.

2. The device of claim 1 further comprising:
e) a lower pocket proximate to the lower edge of the sheet with a second rod therein for maintaining the sheet displayed with the first surface visible while the vehicle is in motion.

3. In combination (i) a vehicle with a trunk and a trunk lid that pivots upwardly to provide access to the trunk and a latch for holding the trunk lid closed, the trunk lid being closed; and (ii) a removable display device on the rear of the vehicle, the display device comprising:
a) a generally rectangular sheet of flexible material having a first outer display surface, a second surface opposed to the first surface, an upper edge, an upper portion, a lower portion, a lower edge, and a cut out in the upper portion receiving the latch;
b) a first display on the first surface visible to persons behind the vehicle; and
c) an upper pocket proximate to the upper edge of the sheet with a first rod therein removably retaining the upper portion of the sheet in the rear compartment of the vehicle when the trunk is closed but not when the trunk is open; and
d) padding for the first rod,
wherein there is no support for the sheet that prevents the sheet from bending so that the upper portion can be placed in the trunk with the lower portion of the sheet draping downwardly so that the display is visible.

4. The combination of claim 3 wherein the display device further comprises:
e) a lower pocket proximate to the lower edge of the sheet with a second rod therein for maintaining the first display displayed while the vehicle is in motion.

5. A display device for placement on the rear of a vehicle that has a rear door that pivots for opening to provide access to a rear compartment of the vehicle and is held closed by a latch, the display device comprising:
a) a sheet of flexible material having a first outer display surface, a second surface opposed to the first surface, an upper portion, a lower portion, an upper edge, and a lower edge;
b) a first display on the first surface;
c) one or more rods at the upper edge of the sheet for removably retaining the sheet in the rear compartment of the vehicle when the rear door is closed but not when the rear door is open;
d) weight down means proximate to the lower edge of the sheet for maintaining the first display surface visible while the vehicle is in motion; and
e) padding for at least one of the rods,
wherein there is no support for the sheet that prevents the sheet from bending so that the upper portion can be placed in the compartment with the lower portion of the sheet draping downwardly so that the display is visible.

6. The device of claim 5 wherein the upper portion of the sheet has an opening for receiving the latch.

7. (canceled)

8. The device of claim 5 wherein the one or more rods are held in a pocket at the upper edge of the sheet.

9. The device of claim 5 wherein the weight down means comprises one or more rods at the lower edge of the sheet.

10. The device of claim 9 wherein the one or more rods comprising the weight down means are held in a pocket at the lower edge of the sheet.

11.-13. (canceled)

14. The device of claim 9 comprising padding for the one or more rods comprising the weight down means.

15. The device of claim 1 comprising a second display on the second surface.

16. The device of claim 5 comprising a display on the second surface.

17. The device of claim 1 wherein the first rod is removable from the sheet.

18. The device of claim 5 wherein the one or more rods at the upper edge of the sheet are removable from the sheet.

19. A method for placing a display on the rear of a vehicle having a rear compartment and a door that pivots for opening to provide access to the rear compartment, comprising the steps of:
a) selecting a display device comprising:
i) a sheet of flexible material having a first outer display surface, a second surface opposed to the first surface, an upper portion, a lower portion, an upper edge, and a lower edge;
ii) a first display on the first surface;
iii) retaining means proximate to the upper edge for removably retaining the sheet in the rear compartment of the vehicle when the rear door is closed but not when the rear door is open; and
iv) weight down means proximate to the lower edge of the sheet for maintaining the first display surface visible while the vehicle is in motion, wherein there is no support for the sheet that prevents the sheet from bending so that the upper portion can be placed in the compartment with the lower portion of the sheet draping downwardly so that the display is visible:
b) with the rear compartment of the vehicle open, placing the retaining means and a portion of the sheet in the compartment with the remainder of the sheet draping over the rear of the vehicle, without physically securing the display device to the vehicle with the first surface facing outwardly from the vehicle and the first display visible; and
c) closing the door.

20. The method of claim 19 wherein the vehicle has a latch for the door and the upper portion of the sheet has an opening sized to receive the latch, and wherein step b) comprises placing the opening over the latch so that the latch extends through the opening and helps retain the display device in place when the door is closed.

21. A display device suitable for placement on the rear of a vehicle that has a trunk and a trunk lid that pivots upwardly for opening to provide access to the trunk, the trunk having a latch, the display device comprising:
a) a generally rectangular sheet of flexible material having first and second opposed surfaces, an upper edge, a lower edge, an upper portion, a lower portion, and a cut out in the upper portion for receiving the latch when the trunk is closed;
b) a first display on the first surface;
c) an upper pocket proximate to the upper edge of the sheet with a first rod therein for removably retaining the sheet in the rear compartment of the vehicle when the trunk lid is closed;
d) a lower pocket proximate to the lower edge of the sheet with a second rod therein for maintaining the sheet displayed with the first surface visible while the vehicle is in motion; and
e) padding for the second rod,
wherein there is no support for the sheet that prevents the sheet from bending so that the upper portion can be placed in the trunk with the lower portion of the sheet draping downwardly so that the display is visible.

22. The device of claim 1 wherein the padding is in the upper pocket around the first rod.

23. The combination of claim 3 wherein the padding is in the upper pocket around the first rod.

24. The device of claim 5 wherein the padding is in the upper pocket around the one or more rods.

25. The device of claim 21 wherein the padding is in the lower pocket around the second rod.
